(19) United States
(12) Patent Application Publication
(10) Pub. No.: US 2014/0189033 A1
(43) Pub. Date: Jul. 3, 2014

(54) COMMUNICATION SYSTEM, SEMICONDUCTOR DEVICE, AND DATA COMMUNICATION METHOD

(71) Applicant: LAPIS Semiconductor Co., Ltd., Yokohama (JP)

(72) Inventor: Hiroji AKAHORI, Yokohama (JP)

(73) Assignee: LAPIS SEMICONDUCTOR CO., LTD., Yokohama (JP)

(21) Appl. No.: 14/142,078

(22) Filed: Dec. 27, 2013

(30) Foreign Application Priority Data
Dec. 28, 2012 (JP) 2012-287841

(51) Int. Cl. G06F 15/173

(52) U.S. Cl. CPC G06F 15/17337
USPC 709/212

(57) ABSTRACT

System and method of data communication and a semiconductor device capable of transmitting information data through a communication interface with a specified response duration without degradation in efficiency of operation. In a first information processing unit, when a first controller issues request signals of predetermined data processing, a first communication interface sends a pseudo response to the first controller in response to one of the request signals and transmits the request signal to a second information processing unit which in turn performs predetermined information processing indicated by the request signal and sends back response data. The first communication interface stores the received response data in memory and reads the response data from memory in response to a request signal issued for the second time onward from the first controller after complete storing of the response data, and then supplies the data to the first controller.

### BACKGROUND OF THE INVENTION

1. Field of the Invention

The present invention relates to a data communication system for performing data communications between information devices using a communication interface with a standardized response time; a semiconductor device on which the communication interface used in such a data communication system is formed; and a data communication method.

2. Background Art

Currently known as such a communication interface is an inter-integrated circuit (I²C) communication interface. For example, when a first information device requests a second information device to read information data using the I²C communication interface, the second information device has to transmit, in response to the readout request, the requested information data to the first information device within a specified response duration. However, if the second information device spends too long an access time before the requested information data is acquired, the information data cannot be transmitted to the first information device within the specified response duration. Thus, at this time, since no reply is sent from the second information device within the specified response duration, the first information device is timed out and proceeds to avoidance processing, for example, for sending a readout request again or interrupting the line for the time being.

Thus, there has been a possibility that the first information device is not able to acquire the information data when the second information device spent too long an access time for acquisition of the information data that the first information device requested to read.

In this context, such a communication system was suggested in which when requested information data cannot be transmitted within a specified response duration in response to a request for reading the information data, a dummy response signal is transmitted within the specified response duration, thereby avoiding a line interruption (for example, see Japanese Patent Application Laid-Open No. H08-130586).

However, according to such a communication system, the information device having issued the readout request has to wait until desired information data is sent thereto from an information device sending the information. Thus, meanwhile, the information device having issued the readout request cannot perform other processing, causing degradation in the efficiency of operation.

### SUMMARY OF THE INVENTION

The present invention has been developed to solve the aforementioned problems. It is therefore an object of the invention to provide a data communication system, a semiconductor device with a communication interface formed thereon, and a data communication method, which can transmit desired information data through a communication interface with a specified response duration without degradation in the efficiency of operation of an information processing unit for performing data communications.

A data communication system according to the present invention includes first and second information processing units. The first information processing unit includes a first controller for intermittently producing request signals to request for the execution of predetermined data processing; and a first communication interface for sending a pseudo response to the first controller in response to one of the request signals and for transmitting the request signal to the second information processing unit. The second information processing unit includes a second controller for receiving one of the request signals, performing the predetermined data processing in response thereto, and producing response data after the data processing has been completed; and a second communication interface for transmitting the response data to the first information processing unit. The data communication system is configured such that the first communication interface stores the received response data in a memory and reads the response data from the memory in response to the request signal produced by the first controller after the response data has been completely stored in the memory and then supplies the response data to the first controller.

On the other hand, a semiconductor device according to the present invention includes first and second information processing units for bidirectionally communicating data with each other. The first information processing unit is made up of a first semiconductor chip which includes: a first controller for intermittently producing request signals to request the execution of predetermined data processing; and a first communication interface for sending a pseudo response to the first controller in response to one of the request signals and for transmitting the request signal to the second information processing unit. The second information processing unit is made up of a second semiconductor chip which includes: a second controller for receiving one of the request signals, performing the predetermined data processing in response thereto, and producing response data after the data processing has been completed; and a second communication interface for transmitting the response data to the first information processing unit. The semiconductor device is configured such that the first communication interface stores the received response data in a memory and reads the response data from the memory in response to the request signal produced by the first controller after the response data has been completely stored in the memory and then supplies the response data to the first controller.

On the other hand, a data communication method according to the present invention is performed between a first information processing unit including a controller for intermittently producing request signals to request the execution of predetermined data processing and a second information processing unit for performing the predetermined data processing. The first information processing unit sends a pseudo response to the controller in response to one of the request signals. When having transmitted one of the request signals to the second information processing unit, the first information processing unit stores response data sent back from the second information processing unit in a memory, reads the response data from the memory in response to the request signal produced by the first controller after the response data has been completely stored in the memory, and supplies the response data to the controller.

In the data communication system according to the present invention, for the first information processing unit to receive response data sent back from the second information processing unit in response to a request signal sent out from the first controller of the first information processing unit, the first communication interface of the first information processing unit immediately sends a pseudo response to the first controller in response to one of the request signals without waiting for the response data. Since this allows the first controller to receive the pseudo response within a prescribed response duration after having sent out the request signal, the first controller can then move onto other processing without performing the avoidance processing. Thus, the first controller can be enhanced in the efficiency of operation.

Furthermore, upon reception of the response data transmitted from the second information processing unit, the first communication interface of the first information processing unit stores the response data in the memory and then reads the response data from the memory in response to a request signal sent out from the first controller after the response data has been completely stored in the memory, that is, a request issued for the second time onward, and supplies the response data to the first controller. Thus, in response to the request issued for the second time onward from the first controller, the response data from the second information processing unit can be acquired without processing for transmission to the second information processing unit and processing in the second information processing unit.

Thus, according to the present invention, even when a response from the second information processing unit is sent after a prescribed response duration in response to a first request issued by the first controller of the first information processing unit, the response contents can be quickly acquired by a request issued for the second time onward from the first controller without degradation in the efficiency of operation of the first information processing unit.

### BRIEF DESCRIPTION OF THE DRAWINGS

FIG. 1 is a block diagram illustrating the configuration of a data communication system according to the present invention;

FIG. 2 is a communication flow diagram showing an example of a communication operation between an information processing main unit 1 and an information processing sub-unit 2 to be performed in response to a readout request from the information processing main unit 1;

FIG. 3 is a communication flow diagram showing an example of a communication operation between the information processing main unit 1 and the information processing sub-unit 2 to be performed in response to a readout request from the information processing main unit 1;

FIG. 4 is a communication flow diagram showing an example of a communication operation between the information processing main unit 1 and the information processing sub-unit 2 to be performed in response to a write request from the information processing main unit 1;

FIG. 5 is a communication flow diagram showing an example of a communication operation between the information processing main unit 1 and the information processing sub-unit 2 to be performed in response to a write request from the information processing main unit 1;

FIG. 6 is a communication flow diagram showing another example of a communication operation between the information processing main unit 1 and the information processing sub-unit 2 to be performed in response to a readout request from the information processing main unit 1; and

FIG. 7 is a communication flow diagram showing another example of a communication operation between the information processing main unit 1 and the information processing sub-unit 2 to be performed in response to a readout request from the information processing main unit 1.

### DETAILED DESCRIPTION OF THE INVENTION

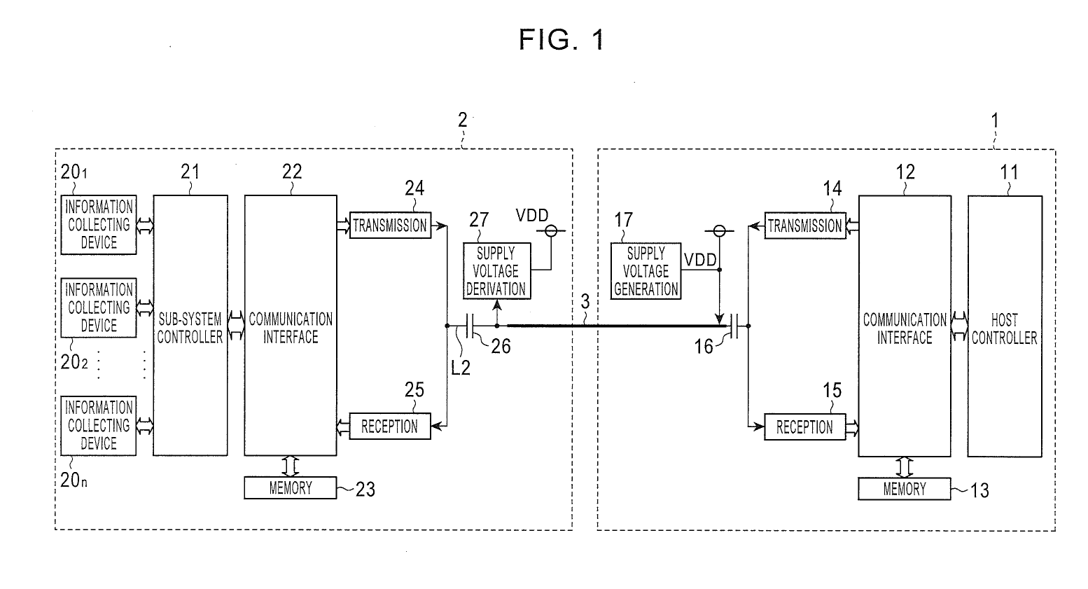

FIG. 1 is a block diagram illustrating the configuration of a data communication system according to the present invention.

The data communication system shown in FIG. 1 is mainly made up of an information processing main unit 1 formed on a first semiconductor chip; an information processing sub-unit 2 formed on a second semiconductor chip; and a transmission cable 3 for connecting between the information processing main unit 1 and the information processing sub-unit 2.

The information processing main unit 1 includes a host controller 11, a communication interface 12, a memory 13, a transmitter circuit 14, a receiver circuit 15, a capacitor 16, and a supply voltage generation circuit 17.

The host controller 11 performs various types of data processing based on information data and a control signal transmitted through the communication interface 12 from the information processing sub-unit 2. For example, when the information processing main unit 1 is a television set, such data processing allows the host controller 11 to reconstruct image data and speech data indicated by the aforementioned information data and then supply each of the resulting data to a display device (not shown). At this time, the host controller 11 supplies, to the communication interface 12, various types of control signals including a readout request signal for reading information data acquired by the information processing sub-unit 2 and a write request signal for writing various types of setting data to set the operation mode of the information processing sub-unit 2.

The communication interface 12 is responsible for communications between the information processing main unit 1 and the information processing sub-unit 2 in accordance with general-purpose interface standards such as the I²C communication interface. When being supplied with a control signal or setting data from the host controller 11, the communication interface 12 accesses the transmitter circuit 14 in order to send the control signal or setting data to the information processing sub-unit 2.

Furthermore, when being supplied with a request signal (a readout request signal or a write request signal) from the host controller 11, the communication interface 12 determines whether response data (to be discussed later) to be produced in the information processing sub-unit 2 in response to the request signal has been stored in the memory 13. At this time, if it is determined that the response data has not yet been stored in the memory 13, the communication interface 12 interprets the aforementioned request signal as the first request signal and sends a pseudo response (to be discussed later) to the host controller 11. On the other hand, if it is determined that the response data has been already stored in the memory 13, the communication interface 12 interprets the request signal supplied from the host controller 11 as the second supplied request signal and will not send the aforementioned pseudo response.

Furthermore, upon reception of the response data transmitted from the information processing sub-unit 2 through the receiver circuit 15, the communication interface 12 stores the data in the memory 13. Then, in response to a request signal supplied from the host controller 11 after the response data has been completely stored in the memory 13, the communication interface 12 reads the response data from the memory 13 and then supplies the resulting data to the host controller 11.

The transmitter circuit 14 performs error-correcting coding and modulation on the various types of control signals and setting data supplied from the communication interface 12 and transmits the resulting modulated signal to the information processing sub-unit 2 through a line L1, the capacitor 16, and the transmission cable 3. The receiver circuit 15 receives the modulated signal having been transmitted from the information processing sub-unit 2 through the transmission cable 3, the capacitor 16, and the line L1 and then performs thereon demodulation and error correction so as to reconstruct the information data or setting data, then supplying the resulting data to the communication interface 12.

One end of the capacitor 16 is connected to the transmission cable 3, while the other end is connected to the output terminal of the transmitter circuit 14 and the input terminal of the receiver circuit 15 through the line L1. The capacitor 16 prevents the direct current component of the transmission cable 3 from flowing into the line L1.

The supply voltage generation circuit 17 generates a DC supply voltage VDD as a power supply for activating each module in the information processing main unit 1, i.e., each of the host controller 11, the communication interface 12, the memory 13, the transmitter circuit 14, and the receiver circuit 15, and supplies the supply voltage VDD thereto. Furthermore, the supply voltage generation circuit 17 applies the supply voltage VDD to the transmission cable 3, thereby supplying the DC supply voltage VDD to the information processing sub-unit 2.

That is, with the DC supply voltage VDD superimposed on the transmission cable 3, data communications are conducted between the information processing main unit 1 and the information processing sub-unit 2 through the transmission cable 3. Note that the DC supply voltage VDD may also be supplied to the information processing sub-unit 2 not through the transmission cable 3 but through a dedicated power supply cable (not shown).

On the other hand, the information processing sub-unit 2 shown in FIG. 1 includes information collecting devices 201 to 20n (n is an integer equal to 2 or greater), a sub-system controller 21, a communication interface 22, a memory 23, a transmitter circuit 24, a receiver circuit 25, a capacitor 26, and a supply voltage derivation circuit 27.

For example, the information collecting devices 201 to 20n are each an antenna for receiving broadcast waves and supply a high-frequency received signal, which each device has obtained by receiving the broadcast waves, as collected data to the sub-system controller 21. Note that the operation mode of the information collecting devices 201 to 20n is set by the setting data supplied from the sub-system controller 21.

When being supplied with a readout request signal from the communication interface 22, the sub-system controller 21 performs predetermined data processing on collected data supplied from the information collecting devices 201 to 20n, thereby producing information data that the information processing sub-unit 2 aims to generate. For example, suppose that the collected data is a high-frequency received signal that the antenna has received and thereby obtained. The sub-system controller 21 demodulates and decodes the high-frequency received signal, thereby producing, as information data, the image and speech data indicative of broadcast contents (images and speech). Then, the sub-system controller 21 supplies, to the communication interface 22, the information data as data to be transmitted to the information processing main unit 1. Furthermore, when being supplied with a write request signal, setting data, and a control signal from the communication interface 22, the sub-system controller 21 performs the aforementioned data processing or data processing for setting the operation mode of the information collecting devices 201 to 20n. Furthermore, the sub-system controller 21 supplies, to the communication interface 22, various types of control signals including a readout request signal or a write request signal or setting data for setting the operation mode of the information processing main unit 1, which are to be sent to the information processing main unit 1.

The communication interface 22 is responsible for communications between the information processing main unit 1 and the information processing sub-unit 2 in accordance with general-purpose interface standards, for example, like the I²C communication interface. When being supplied with a control signal or setting data from the sub-system controller 21, the communication interface 22 accesses the transmitter circuit 24 in order to transmit the signal or data to the information processing main unit 1. Furthermore, like the aforementioned communication interface 12, the communication interface 22 sends a pseudo response to the sub-system controller 21 in response to the readout request signal or the write request signal supplied for the first time from the sub-system controller 21. Furthermore, when being supplied with setting data from the receiver circuit 25, the communication interface 22 relays and supplies the data to the sub-system controller 21 while storing the data in the memory 23. Meanwhile, when being supplied with a readout request signal or write request signal, which is issued for the second time onward from the receiver circuit 25, the communication interface 22 relays and supplies the signal to the sub-system controller 21.

The transmitter circuit 24 performs error-correcting coding and modulation on the control signal and information data supplied from the communication interface 22 and then transmits the resulting modulated signal to the information processing main unit 1 through a line L2, the capacitor 26, and the transmission cable 3. The receiver circuit 25 receives the modulated signal transmitted from the information processing main unit 1 through the transmission cable 3, the capacitor 26, and the line L2, and performs demodulation and error correction on the signal. This allows the receiver circuit to reconstruct the various types of control signals, including the readout request signal and the write request signal, and the setting data and supply the resulting signal and data to the communication interface 22.

One end of the capacitor 26 is connected to the transmission cable 3, while the other end is connected to the output terminal of the transmitter circuit 24 and the input terminal of the receiver circuit 25 through the line L2. The capacitor 26 prevents the DC component of the transmission cable 3 from flowing into the line L2.

The supply voltage derivation circuit 27 derives the DC supply voltage VDD superimposed on the transmission cable 3. Then, the supply voltage derivation circuit 27 supplies the supply voltage VDD to each of the information collecting devices 201 to 20n, the sub-system controller 21, the communication interface 22, the memory 23, the transmitter circuit 24, and the receiver circuit 25 as power source for operating each of them.

Now, a description will be made to the communication operation to be conducted in the data communication system shown in FIG. 1.

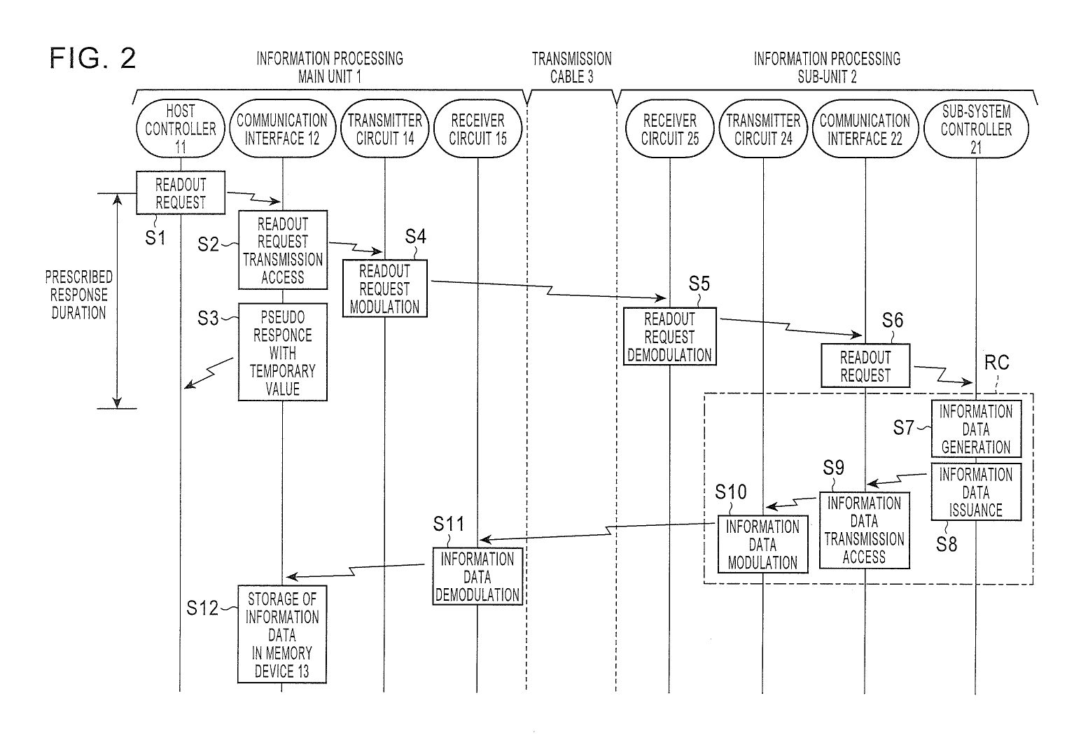

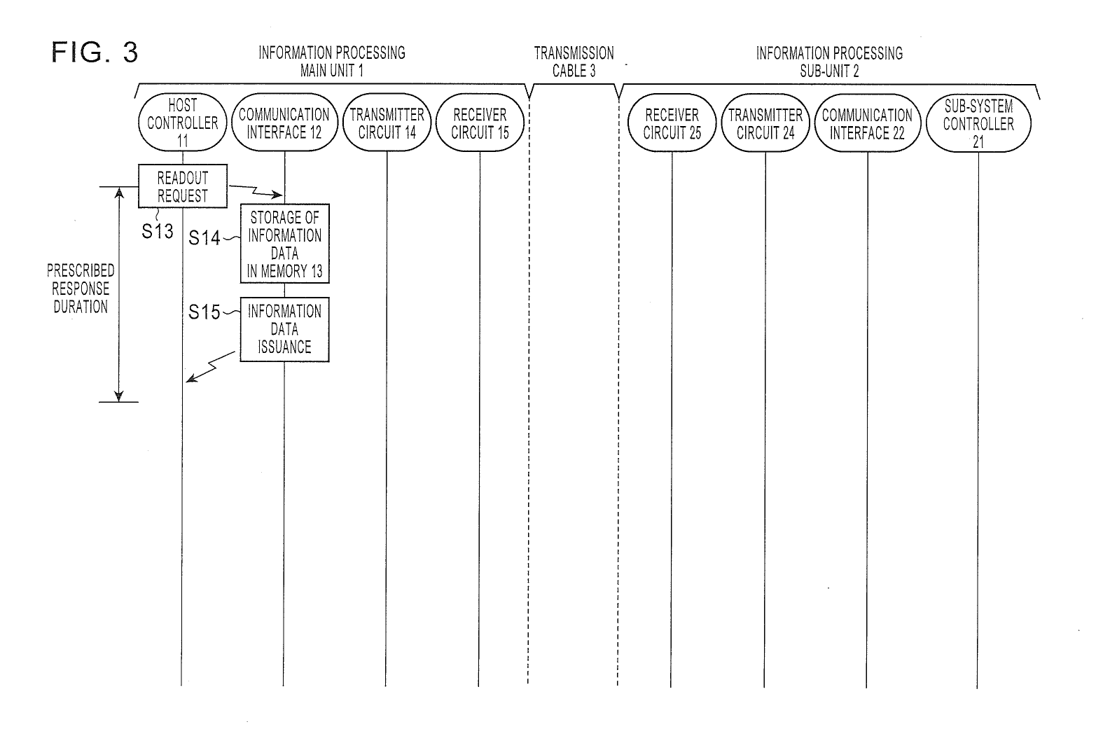

FIGS. 2 and 3 are each a communication flow diagram showing the procedure of data communications which is taken until information data acquired by the information processing sub-unit 2 is transmitted to the information processing main unit 1 in response to a readout request generated by the host controller 11 of the information processing main unit 1.

First, the host controller 11 supplies, to the communication interface 12, a first readout request signal for reading information data acquired by the information processing sub-unit 2 (Step S1). In response to the readout request signal, the communication interface 12 first determines whether the readout request signal has been supplied for the first time. That is, when no information data produced by the information processing sub-unit 2 in response to the readout request signal has been stored in the memory 13, the communication interface 12 determines that the readout request signal has been supplied for the first time. At this time, in Step S1 above, since the readout request signal has been supplied for the first time, the communication interface 12 accesses the transmitter circuit 14 in order to transmit the readout request signal to the information processing sub-unit 2 (Step S2), and subsequently provides pseudo response control. That is, after the execution of Step S2, the communication interface 12 immediately sends a pseudo response for supplying a predetermined temporary value to the host controller 11 as information data without waiting for a response (reception of information data) from the information processing sub-unit 2 (Step S3). As shown in FIG. 2, this allows the host controller 11 to issue a readout request (S1) and then receive a temporary value as a pseudo response within a prescribed response duration. Note that the prescribed response duration is specified by a general-purpose interface (for example, the I²C communication interface) employed in the data communication system shown in FIG. 1 and is the maximum time that is allowed to elapse until the response is sent after the request is issued. At this time, if no response is sent within the prescribed response duration, the requestor cancels the communication for the time being and then moves onto avoidance processing, for example, for issuing a readout request again. Thus, sending the pseudo response in Step S3 makes it possible to move onto the execution of other required processing without performing the avoidance processing.

Furthermore, when being accessed by executing Step S2 above in order to transmit the readout request signal to the information processing sub-unit 2, the transmitter circuit 14 transmits a modulated signal obtained by modulating the readout request signal to the information processing sub-unit 2 through the transmission cable 3 (Step S4). Upon reception of the modulated signal, the receiver circuit 25 of the information processing sub-unit 2 demodulates the signal, thereby reconstructing the readout request signal and then supplying the resulting signal to the communication interface 22 (Step S5). When being supplied with the readout request signal, the communication interface 22 relays and supplies the readout request signal to the sub-system controller 21 (Step S6). In response to the readout request signal supplied from the communication interface 22, the sub-system controller 21 collects data from each of the information collecting devices 201 to 20n and then produces desired information data on the basis of the data collected (Step S7). Next, the sub-system controller 21 sends out such information data to the communication interface 22 (Step S8). The communication interface 22 accesses the transmitter circuit 24 in order to transmit, to the information processing main unit 1, the information data supplied from the sub-system controller 21 (Step S9). In response to such access, the transmitter circuit 24 transmits the modulated signal obtained by modulating the information data to the information processing main unit 1 through the transmission cable 3 (Step S10). Upon reception of the modulated signal, the receiver circuit 15 of the information processing main unit 1 demodulates the signal, thereby reconstructing the information data and then supplying the resulting data to the communication interface 12 (Step S11). The communication interface 12 stores the information data supplied from the receiver circuit 15 in the memory 13 (Step S12).

After that, as shown in FIG. 3, the host controller 11 supplies, to the communication interface 12, the same readout request signal as the readout request signal sent out in Step S1 above, that is, a readout request signal issued for the second time onward (Step S13). In response to the readout request signal, the communication interface 12 determines whether the information data produced by the information processing sub-unit 2 has been stored in the memory 13. At this time, since the information data has been stored in the memory 13, the communication interface 12 interprets the readout request signal as one supplied for the second time onward, reads the information data stored in the memory 13 in response to the readout request signal issued for the second time onward (Step S14), and sends out the resulting data to the host controller 11 (Step S15). This allows the host controller 11 to acquire the information data in response to the readout request, that is, the information data produced by the information processing sub-unit 2.

Now, a description will be made to the communication operation to be performed in response to a write request issued from the host controller 11 of the information processing main unit 1.

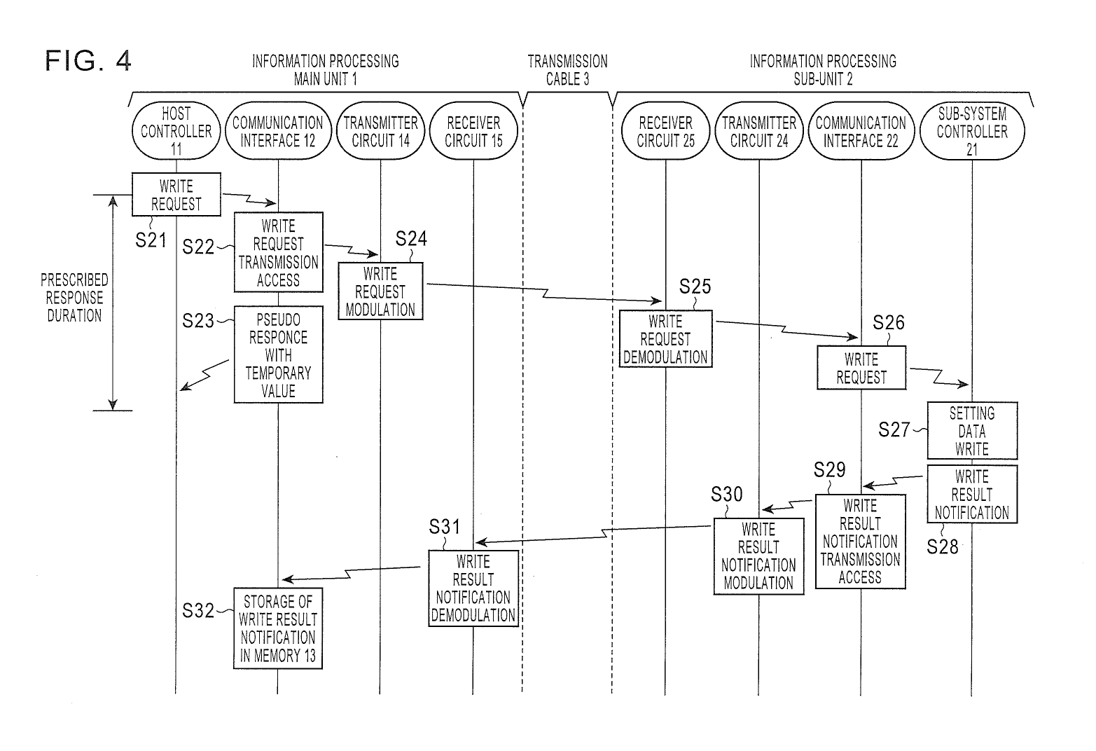

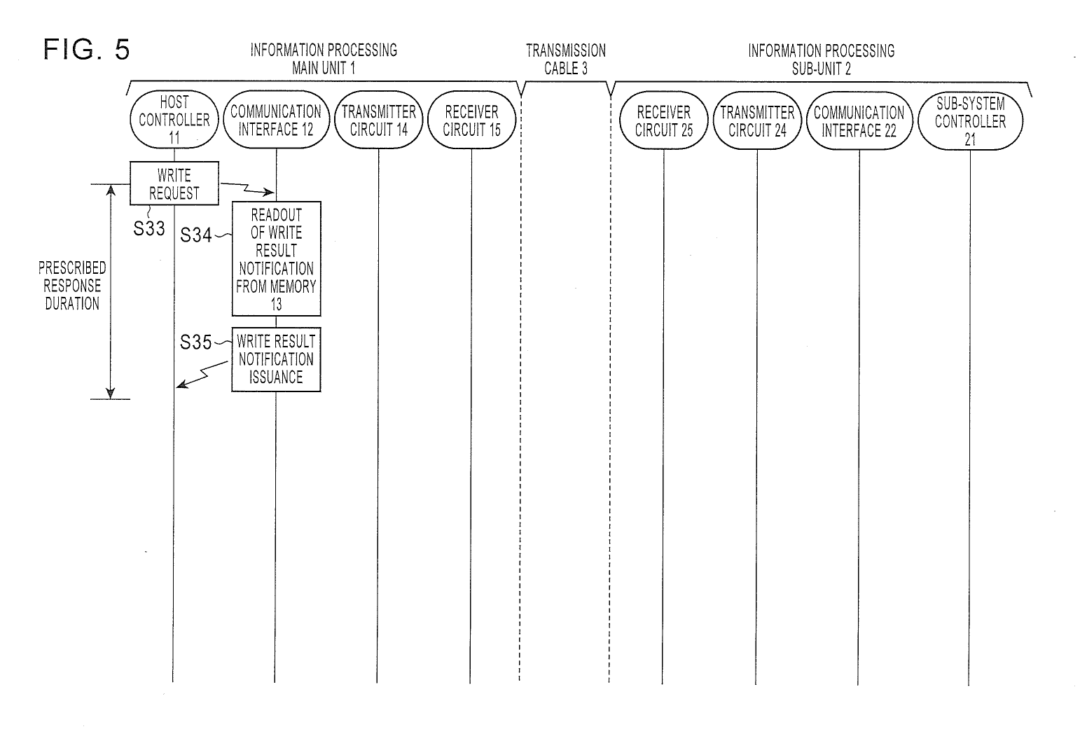

FIGS. 4 and 5 are each a communication flow diagram showing the procedure of data communications which is taken by the information processing sub-unit 2 in response to a write request issued from the host controller 11 so as to transmit the write result (whether the writing has been successfully performed) to the information processing main unit 1.

First, the host controller 11 supplies, to the communication interface 12, a write request signal for allowing setting data for setting a mode of operation to be written in the information processing sub-unit 2 (Step S21). In response to the write request signal, the communication interface 12 first determines whether the write request signal has been supplied for the first time. That is, when write result notification data (to be discussed later) produced by the information processing sub-unit 2 in response to the write request signal has not yet been stored in the memory 13, the communication interface 12 determines that this write request signal has been supplied for the first time. At this time, in Step S21 above, since the write request signal has been supplied for the first time, the communication interface 12 accesses the transmitter circuit 14 in order to transmit the write request signal to the information processing sub-unit 2 (Step S22) and subsequently performs the pseudo response control. That is, after the execution of Step S22, the communication interface 12 provides the pseudo response for immediately supplying, to the host controller 11, a predetermined temporary value as the write result notification data without waiting for a response (the reception of the write result notification data) from the information processing sub-unit 2 (Step S23). As shown in FIG. 4, this allows the host controller 11 to receive the temporary value as the pseudo response within the prescribed response duration from the time of issuing the write request (S21). Thus, it is possible for the host controller 11 to move subsequently onto other processing without moving on to the avoidance processing.

Furthermore, when being accessed by executing Step S22 above in order to transmit the write request signal to the information processing sub-unit 2, the transmitter circuit 14 transmits a modulated signal obtained by modulating the write request signal to the information processing sub-unit 2 through the transmission cable 3 (Step S24). Upon reception of the modulated signal, the receiver circuit 25 of the information processing sub-unit 2 demodulates the signal, thereby reconstructing the write request signal and then supplying the signal to the communication interface 22 (Step S25). When being supplied with the write request signal, the communication interface 22 relays and supplies the write request signal to the sub-system controller 21 (Step S26). In response to the write request signal supplied from the communication interface 22, the sub-system controller 21 writes the setting data that is indicated by the write request signal and then sets the mode of operation in accordance with the setting data (Step S27). At this time, the sub-system controller 21 generates the write result notification data indicative of whether the setting data has been successfully written and then sends out the data to the communication interface 22 (Step S28). Then, the communication interface 22 accesses the transmitter circuit 24 in order to transmit, to the information processing main unit 1, the write result notification data supplied from the sub-system controller 21 (Step S29). In response to such access, the transmitter circuit 24 transmits the modulated signal obtained by modulating the write result notification data to the information processing main unit 1 through the transmission cable 3 (Step S30). Upon reception of the modulated signal, the receiver circuit 15 of the information processing main unit 1 demodulates the signal, thereby reconstructing the write result notification data and supplying the resulting data to the communication interface 12 (Step S31). The communication interface 12 stores the write result notification data supplied from the receiver circuit 15 in the memory 13 (Step S32).

After that, as shown in FIG. 5, the host controller 11 supplies, to the communication interface 12, the same write request signal as the write request signal sent out in Step S21 above, that is, a write request signal issued for the second time onward (Step S33). In response to the write request signal, the communication interface 12 determines whether the write request signal has been supplied for the first time. That is, the communication interface 12 determines whether the write result notification data produced by the information processing sub-unit 2 in response to the write request signal has been stored in the memory 13. At this time, since the write result notification data has been stored in the memory 13, the communication interface 12 determines that this write request signal has been supplied for the second time onward. Thus, the communication interface 12 reads the write result notification data stored in the memory 13 (Step S34) and then sends out the resulting data to the host controller 11 (Step S35). This allows the host controller 11 to acquire the write result notification data indicative of whether the setting data has been successfully written in the information processing sub-unit 2.

As described above, in the data communications shown in FIGS. 2 to 5, first, a first controller included as the host controller 11 in a first information processing unit serving as the information processing main unit 1 intermittently produces request signals (the readout request signal or the write request signal) for requesting the execution of predetermined data processing (reading of information data or writing of setting data). At this time, in response to one of the request signals, the first communication interface (12, 14, 15) included in the first information processing unit sends a pseudo response to the first controller (S3 and S23) and transmits the request signal to the second information processing unit serving as the information processing sub-unit 2. Upon reception of the request signal, the second controller included as the sub-system controller 21 in the second information processing unit performs predetermined data processing (acquiring of information data or writing of setting data) in response to the request signal and upon completion of the data processing, produces response data (information data or write result notification data) indicative of the result of the processing. Then, the second communication interface (22, 24, 25) included in the second information processing unit transmits the response data to the first information processing unit. At this time, the first communication interface of the first information processing unit stores the received response data in the memory (13) and in response to a request signal sent out from the first controller after the response data has been completely stored in the memory, that is, a request signal issued for the second time onward, reads the response data from the memory, and then supplies the resulting data to the first controller.

As described above, in the data communications shown in FIGS. 2 to 5, in response to the request signal sent out from the first controller of the first information processing unit, the first communication interface immediately sends a pseudo response to the first controller without waiting for a response from the second information processing unit.

This allows the first controller to receive the pseudo response within a prescribed response duration after the request signal has been sent out. Thus, it is possible for the first controller to move subsequently onto other processing without performing the avoidance processing, thus enhancing the efficiency of operation of the first controller.

Furthermore, in the data communications shown in FIGS. 2 to 5, the first communication interface of the first information processing unit receives the response data transmitted from the second information processing unit and then stores the resulting data in the memory irrespective of whether the data has been received within a prescribed response duration. At this time, in response to a request signal issued from the first controller after the response data has been completely stored in the memory, that is, a request signal issued for the second time onward, the first communication interface reads the response data stored in the memory and supplies the data to the first controller. That is, in response to a request issued from the first controller for the second time onward, the response data from the second information processing unit (the information data or the write result notification data) can be acquired without performing processing for transmission to the second information processing unit (S4 and S24) and processing in the second information processing unit (S5 to S10 and S25 to S30).

Thus, according to the present invention, even when a response from the second information processing unit (2) in response to the first request issued by the first controller (11) of the first information processing unit (1) is sent after a prescribed response duration, it is possible to quickly acquire the response contents by the request issued from the first controller for the second time onward without degradation in the efficiency of operation of the first information processing unit.

Furthermore, in the aforementioned embodiment, in response to the first readout request (S1) or write request (S21) issued from the information processing main unit 1, the information processing sub-unit 2 issues a response only once, that is, transmits the information data (S7 to S10) or the write result notification data (S27 to S30); however, such a response may also be repeated a plurality of times.

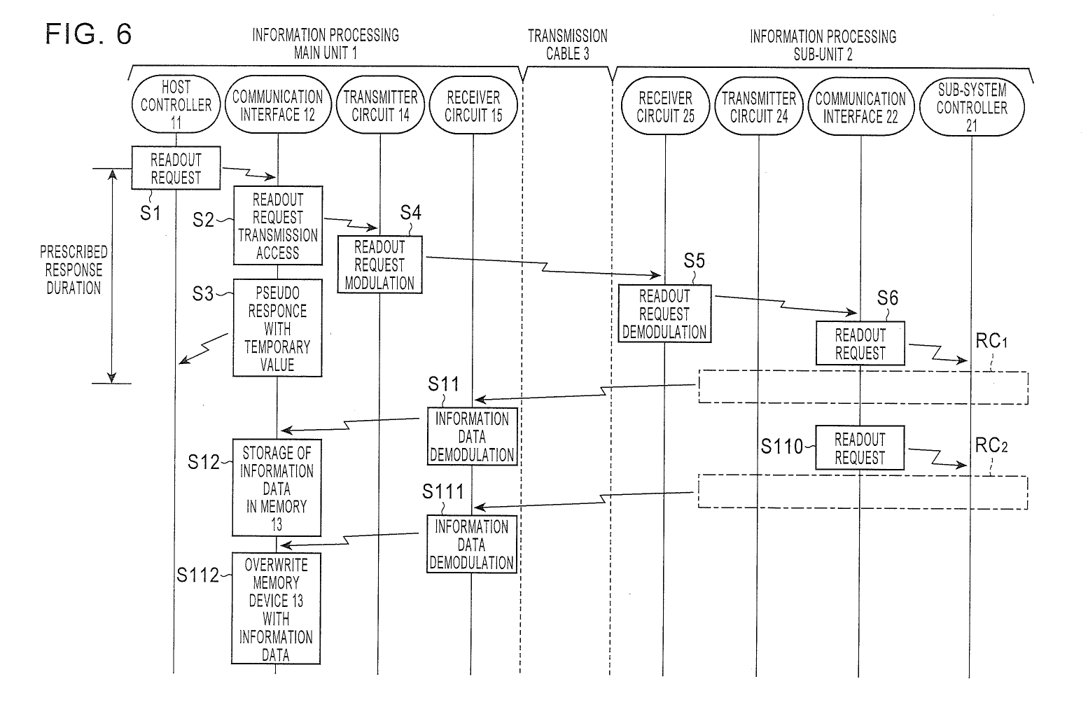

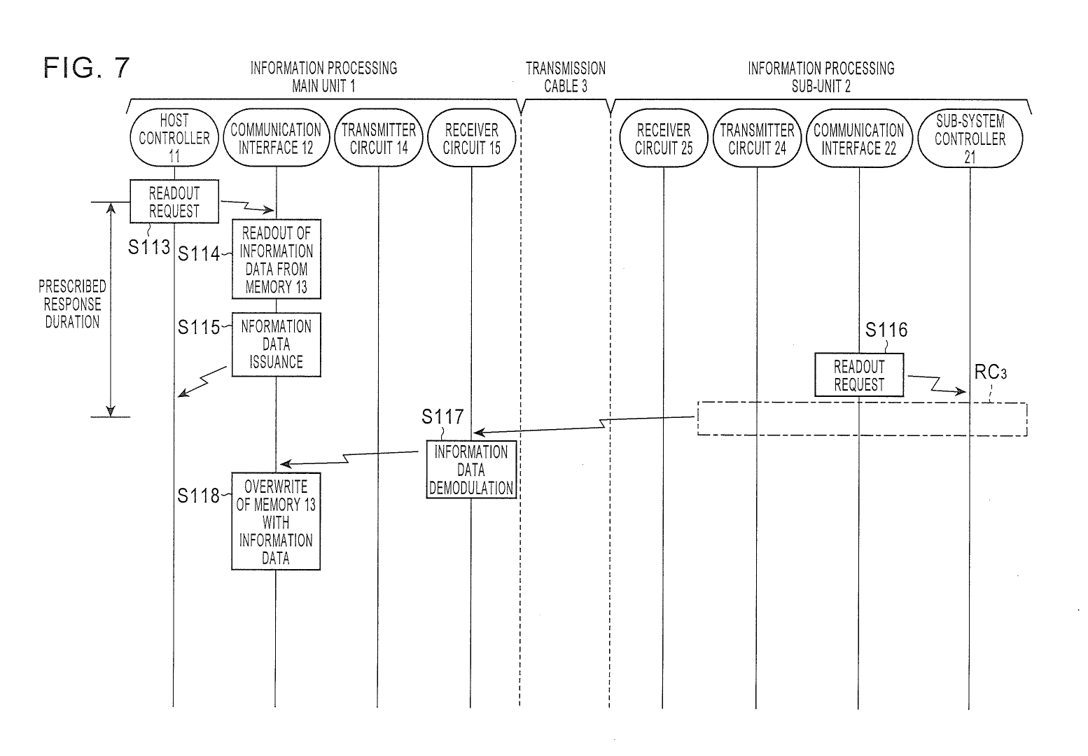

FIGS. 6 and 7 are each a communication flow diagram illustrating another example of the communication procedure developed in view of the alternative mentioned above. Note that in the communications shown in FIGS. 6 and 7, in response to a readout request issued from the host controller 11 of the information processing main unit 1, the information processing sub-unit 2 transmits, for a plurality of times, information data requested for readout.

Note that in FIGS. 6 and 7, the transmission sequence of the readout request signal made up of Steps S1 to S4 to be performed in the information processing main unit 1 is the same as that shown in FIG. 2. Here, upon reception of a modulated signal (a readout request signal) transmitted from the information processing main unit 1 by performing such a transmission sequence (S1 to S4), the receiver circuit 25 of the information processing sub-unit 2 demodulates and thereby reconstructs the readout request signal, then supplying the resulting signal to the communication interface 22 (S5). When being supplied with the readout request signal, the communication interface 22 relays and supplies the first readout request signal to the sub-system controller 21 (S6). At this time, in response to the first readout request signal supplied from the communication interface 22, the sub-system controller 21, the communication interface 22, and the transmitter circuit 24 perform processing in accordance with a first response sequence RC₁ including the same processing steps as Steps S7 to S10 which constitute the response sequence RC shown in FIG. 2. By performing the first response sequence RC₁, the modulated signal obtained by modulating the information data acquired by the sub-system controller 21 is transmitted to the information processing main unit 1 through the transmission cable 3. Upon reception of the modulated signal, the receiver circuit 15 of the information processing main unit 1 demodulates the modulated signal to thereby reconstruct the information data and supplies the resulting data to the communication interface 12 (S11). This causes the communication interface 12 to store the information data supplied from the receiver circuit 15 in the memory 13 (S12).

Here, when the first response sequence RC₁ comes to an end, the communication interface 22 subsequently supplies the second readout request signal to the sub-system controller 21 (Step S110). At this time, in response to the second readout request signal supplied from the communication interface 22, the sub-system controller 21, the communication interface 22, and the transmitter circuit 24 perform the processing in accordance with a second response sequence RC₂ including the same processing steps as those of the response sequence RC shown in FIG. 2. By performing the second response sequence RC₂, the modulated signal obtained by modulating the information data acquired by the sub-system controller 21 is transmitted to the information processing main unit 1 through the transmission cable 3. Upon reception of the modulated signal, the receiver circuit 15 of the information processing main unit 1 demodulates the modulated signal to thereby reconstruct the information data and supplies the resulting data to the communication interface 12 (Step S111). This causes the communication interface 12 to overwrite the information data supplied from the receiver circuit 15 in the memory 13 (Step S112). That is, the information data stored in the memory 13 in Step S12 above is updated to new information data.

After that, as shown in FIG. 8, the host controller 11 supplies the readout request signal issued for the second time onward to the communication interface 12 (Step S113). In this case, in response to the readout request signal issued for the second time onward, the communication interface 12 reads the information data stored in the memory 13 (Step S114) and then sends the resulting data to the host controller 11 (Step S115). This allows the host controller 11 to acquire the information data which the sub-system controller 21 has acquired in response to the second readout request issued by the communication interface 22. Note that when the aforementioned second response sequence RC₂ comes to an end, the communication interface 22 subsequently supplies a third readout request signal to the sub-system controller 21 (Step S116). At this time, in response to the third readout request signal supplied from the communication interface 22, the sub-system controller 21, the communication interface 22, and the transmitter circuit 24 perform processing in accordance with a third response sequence RC₃ including the same processing steps as those of the response sequence RC shown in FIG. 2. By performing the third response sequence RC₃, the modulated signal obtained by modulating the information data acquired by the sub-system controller 21 is transmitted to the information processing main unit 1 through the transmission cable 3. Upon reception of the modulated signal, the receiver circuit 15 of the information processing main unit 1 demodulates the modulated signal to thereby reconstruct the information data and supplies the resulting data to the communication interface 12 (Step S117). This causes the communication interface 12 to overwrite the information data supplied from the receiver circuit 15 in the memory 13 (Step S117). That is, the information data overwritten in the memory 13 in Step S112 above is updated to new information data.

That is, in the data communications shown in FIGS. 6 and 7, in response to the first request (readout or write) from the first controller (11) of the first information processing unit (1), the second communication interface (22, 24, 25) of the second information processing unit (2) repeatedly performs processing (acquiring of information data or writing of setting data) associated with the request and then sends the response contents to the first information processing unit. At this time, each time the response is returned from the second information processing unit, the first communication interface (12, 14, 15) of the first information processing unit overwrites and stores the response contents in the memory (13) (S12, S112, S118).

Thus, according to such data communications, the first information processing unit can read the response contents from the memory included therein in response to a request issued for the second time onward by the first controller of the first information processing unit, thereby always quickly acquiring the latest response contents.

This application is based on Japanese Patent Application No. 2012-287841 which is herein incorporated by reference.

What is claimed is:

1. A data communication system comprising a first information processing unit and a second information processing unit,
the first information processing unit including: a first controller for intermittently producing request signals to request for execution of predetermined data processing; and a first communication interface for sending a pseudo response to the first controller in response to one of the request signals and for transmitting the request signal to the second information processing unit,
the second information processing unit including: a second controller for receiving one of the request signals, performing the predetermined data processing in response thereto, and producing response data after the data processing has been completed; and a second communication interface for transmitting the response data to the first information processing unit, wherein
the first communication interface stores the received response data in a memory and reads the response data from the memory in response to the request signal produced by the first controller after the response data has been completely stored in the memory and then supplies the response data to the first controller.

2. The data communication system according to claim 1, wherein the second communication interface repeatedly transmits the response data to the first information processing unit.

3. The data communication system according to claim 1, wherein
the predetermined data processing is readout processing for reading information data acquired by the second controller, and
the response data is the information data.

4. The data communication system according to claim 2, wherein
the predetermined data processing is readout processing for reading information data acquired by the second controller, and
the response data is the information data.

5. The data communication system according to claim 1, wherein
the predetermined data processing is write processing for writing data to the second controller, and
the response data is write result notification data indicative of whether the write processing has been successfully performed.

6. The data communication system according to claim 2, wherein
the predetermined data processing is write processing for writing data to the second controller, and
the response data is write result notification data indicative of whether the write processing has been successfully performed.

7. The data communication system according to claim 1, comprising a transmission cable for transmitting the response data and the request signal between the first information processing unit and the second information processing unit, and wherein
the first information processing unit further includes a supply voltage generation and supply part which generates a DC supply voltage for operating the second information processing unit and applies the resulting voltage to the transmission cable, and
the second information processing unit further includes a supply voltage derivation part which derives the supply voltage from the transmission cable.

8. The data communication system according to claim 2, comprising a transmission cable for transmitting the response data and the request signal between the first information processing unit and the second information processing unit, and wherein
the first information processing unit further includes a supply voltage generation and supply part which generates a DC supply voltage for operating the second information processing unit and applies the resulting voltage to the transmission cable, and
the second information processing unit further includes a supply voltage derivation part which derives the supply voltage from the transmission cable.

9. The data communication system according to claim 3, comprising a transmission cable for transmitting the response data and the request signal between the first information processing unit and the second information processing unit, and wherein
the first information processing unit further includes a supply voltage generation and supply part which generates a DC supply voltage for operating the second information processing unit and applies the resulting voltage to the transmission cable, and
the second information processing unit further includes a supply voltage derivation part which derives the supply voltage from the transmission cable.

10. The data communication system according to claim 4, comprising a transmission cable for transmitting the response data and the request signal between the first information processing unit and the second information processing unit, and wherein
the first information processing unit further includes a supply voltage generation and supply part which generates a DC supply voltage for operating the second information processing unit and applies the resulting voltage to the transmission cable, and
the second information processing unit further includes a supply voltage derivation part which derives the supply voltage from the transmission cable.

11. A semiconductor device comprising a first information processing unit and a second information processing unit for bidirectionally communicating data with each other,
the first information processing unit comprising a first semiconductor chip which includes: a first controller for intermittently producing request signals to request execution of predetermined data processing; and a first communication interface for sending a pseudo response to the first controller in response to one of the request signals and for transmitting the request signal to the second information processing unit,
the second information processing unit comprising a second semiconductor chip which includes: a second controller for receiving one of the request signals, performing the predetermined data processing in response thereto, and producing response data after the data processing has been completed; and a second communication interface for transmitting the response data to the first information processing unit, wherein
the first communication interface stores the received response data in a memory and reads the response data from the memory in response to the request signal produced by the first controller after the response data has been completely stored in the memory and then supplies the response data to the first controller.

12. The semiconductor device according to claim 11, wherein the second communication interface repeatedly transmits the response data to the first information processing unit.

13. The semiconductor device according to claim 11, comprising a transmission cable for transmitting the response data and the request signal between the first information processing unit and the second information processing unit, and wherein
the first information processing unit further includes a supply voltage generation and supply part which generates a DC supply voltage for operating the second information processing unit and applies the resulting voltage to the transmission cable, and
the second information processing unit further includes a supply voltage derivation part which derives the supply voltage from the transmission cable.

14. The semiconductor device according to claim 12, comprising a transmission cable for transmitting the response data and the request signal between the first information processing unit and the second information processing unit, and wherein
the first information processing unit further includes a supply voltage generation and supply part which generates a DC supply voltage for operating the second information processing unit and applies the resulting voltage to the transmission cable, and
the second information processing unit further includes a supply voltage derivation part which derives the supply voltage from the transmission cable.

15. A data communication method performed between a first information processing unit including a controller for intermittently producing request signals to request execution of predetermined data processing and a second information processing unit for performing the predetermined data processing, wherein
the first information processing unit sends a pseudo response to the controller in response to one of the request signals; when having transmitted one of the request signals to the second information processing unit, stores response data sent back from the second information processing unit in a memory; reads the response data from the memory in response to the request signal produced by the first controller after the response data has been completely stored in the memory; and supplies the response data to the controller.
